(19) United States
(12) Patent Application Publication
(10) Pub. No.: US 2022/0176449 A1
(43) Pub. Date: Jun. 9, 2022

(54) ULTRASONIC ADDITIVE MANUFACTURING OF BOX-LIKE PARTS

(71) Applicant: Divergent Technologies, Inc., Los Angeles, CA (US)

(72) Inventors: Narender Shankar LAKSHMAN, Hermosa Beach, CA (US); Michael Thomas KENWORTHY, Rancho Palos Verdes, CA (US); Taylor Caitlin DOTY, Redondo Beach, CA (US)

(21) Appl. No.: 17/520,565

(22) Filed: Nov. 5, 2021

Related U.S. Application Data
(60) Provisional application No. 63/122,358, filed on Dec. 7, 2020.

(51) Int. Cl. B22F 10/20; B23K 20/10; B33Y 10/00

(52) U.S. Cl. CPC B22F 10/20; B33Y 10/00; B23K 20/10

(57) ABSTRACT

Ultrasonic additive manufacturing (UAM) of surface members for a box-like part such as a crash structure or load-bearing structure in a vehicle is disclosed. In one aspect of the disclosure, a method for building a box-like part includes 3-D printing separately, using UAM, the one or more flat surface members in a horizontal plane relative to a print substrate. The method further includes assembling together the surface members at or proximate respective edges thereof to form the box-like part. In some embodiments, protrusions and other features are added to the surface members. In embodiments involving crash structures, trenches are machined into the inner surfaces to enable tailored deformation of the crash structure during an impact event.

### CROSS REFERENCE TO RELATED APPLICATION(S)

This application claims the benefit of U.S. Provisional Application Ser. No. 63/122,358, entitled “ULTRASONIC ADDITIVE MANUFACTURING OF BOX-LIKE PARTS” and filed on Dec. 7, 2020, the disclosure of which is expressly incorporated by reference herein in its entirety.

### BACKGROUND

### Field

The present disclosure relates generally to vehicles and other transport structures, and more particularly, to manufacturing box-like parts in vehicle-based applications.

### Background

Multi-surface “box-like” parts are used for a variety of purposes in numerous applications in the manufacture of vehicles and other mechanized assemblies. Box-like parts may include a plurality of surface members bounding an inner region, such as vehicular crash structures and extrusion beams, among other structures.

Conventional techniques to manufacture box-like parts can be difficult and expensive. Where commercial-off-the-shelf (“COTS”) parts are unavailable due to the distinctive geometry or size of the surface members, build options can become limited. The box-like part can be machined, and thereafter any interior components can be assembled within. This alternative can be expensive and impractical, especially for surfaces having unique shapes or multiple features. Machining can also result in significant wasted material, particularly if only a small portion of the surface members deviate in size and shape, with the remainder being generally flat.

The box-like part may be instead three-dimensionally (3-D) printed. Although an increasingly viable option for numerous applications, 3-D printing alone may be inefficient for rendering a box-like part because the “Z” or vertical direction of the print would often be unutilized except for the part's vertical surface edges. This can slow the print time and waste powder for powder-based 3-D print technologies. Other instances of 3-D printing box-like parts may utilize an increased amount of support structures to support overhanging regions, which are often removed through a post-processing operation after the 3-D printing process is complete. This disadvantageously imposes manufacturing costs and efficiency penalties on the part.

### SUMMARY

The following presents a simplified summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In various aspects, a method for building a box-like part having surface members is disclosed. The surface members include one or more flat surface members. The method includes 3-D printing separately the one or more flat surface members in a horizontal plane relative to a print substrate. The 3-D printing includes ultrasonic additive manufacturing (UAM). The method further includes assembling together the surface members at or proximate respective edges thereof to form the box-like part.

In various aspects, a method for building a box-like part including surface members is disclosed. The surface members include flat surface members. The method includes 3-D printing, using ultrasonic additive manufacturing (UAM), each flat surface member in a horizontal plane relative to a print substrate. The method further includes 3-D printing, using the UAM, one or more vertical protrusions extending from an edge or an area proximate an edge of each flat surface member such that the deposited print strips in a vertical direction is limited to the one or more vertical protrusions. The method also includes connecting the surface members using the protrusions to form the box-like part.

In various aspects a method for building a box-like part is disclosed. The method includes 3-D printing, using ultrasonic additive manufacturing, a plurality of flat surface members and a plurality of protrusions located at or proximate one or more edges of each flat surface member of the plurality of flat surface members. The method includes connecting the flat surface members with each other and with one or more non-flat structures using the protrusions.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIG. 1A is a perspective view of a UAM 3-D printer.

FIG. 1B is a side cross-sectional view of a UAM 3-D printer with an integrated CNC machine.

FIG. 2 is a perspective view of a surface member with protrusions.

FIG. 3 is a perspective view of a surface member with grooves.

FIG. 4 is a perspective view of two connected surface members.

FIG. 5 is a perspective view of three connected surface members.

FIG. 6 is a perspective view of a box-like part assembled in part from surface members in FIGS. 4-6.

FIG. 7 is a perspective view of another surface member with protrusions.

FIG. 8 is a perspective view of another surface member with grooves.

FIG. 9 is a perspective view of two connected surface members.

FIG. 10 is a perspective view of a box-like part assembled in part from the surface members in FIGS. 7-9.

FIG. 11 is a cross-sectional view of an edge of a surface member with different materials.

FIG. 12A is a cross sectional view of a portion of a multi-layer surface member.

FIG. 12B is a cross sectional view of a portion of a multi-layer surface members 3-D printed to include special features.

FIG. 12C is a perspective view of a cylindrical PBF fluid passage channel.

FIG. 12D is a cross sectional view of a portion of a multi-layer surface member with the fluid passage channel of FIG. 12C inserted.

FIG. 13A is an cross-sectional side view of an exemplary crash structure using surface members with distributed trenches.

FIG. 13B is a cross-sectional side view of another exemplary crash structure using surface members with distributed trenches.

FIG. 14 is a cross sectional side view of an exemplary load-bearing structure using COTS panels.

FIG. 15 is an exemplary flow diagram of a method for building box-like part using UAM.

FIG. 16 is an exemplary flow diagram a method for building box-like part using UAM.

FIG. 17 is an exemplary flow diagram a method for building box-like part using UAM.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

The present disclosure is generally directed to techniques for manufacturing box-like parts using UAM. Box-like parts refer to a broad category of components that may include, for example, a plurality of at generally flat outer surface members that encompass one or more interior regions. In some embodiments, the regions may be configured to house sub-components. These sub-components may include fluid ducts, electronic circuits, load-bearing networks or lattices, and the like. The structures may be hollow. The regions may also include features arranged on the interior surface of the surface members. The surface members may be substantially flat, although the surface members may also include different features that can cause the surface members to have surfaces with a variable shape in at least certain regions. In some cases, not all surface members are flat.

In one aspect of the disclosure UAM is used to manufacture box-like parts. In lieu of manufacturing it as an integral part, the box-like part is manufactured by strategically using UAM to separately 3-D print each of the flat surface members that will subsequently bound the box-like part. That is, the use of UAM to manufacture the individual flat surface members allows manufacturers to benefit from the high-throughput nature of manufacturing structures in the X-Y (horizontal) plane, as is characteristic of UAM. In various embodiments, the surface members may be 3-D printed to include different features. For example, in some embodiments, a CNC machine assembly integrated in a UAM printer can be used to form distributed arrays of trenches across an interior surface of one or more of the surface members. The machining can in various embodiments be formed during the UAM process, such as when a CNC machine is integrally formed with a UAM printer. The machining can in some embodiments be part of the post-processing. In some embodiments, the surface members may be printed with layers of different material to achieve specific desired properties when the surface members are integrated into the box-like part. In various embodiments, the surface members may be 3-D printed with protrusions, grooves, or a combination of these features, to facilitate the connection of the different surface members. In still additional embodiments, some of the surface members may be printed using an alternate 3-D printing method such as a powder bed fusion (PBF) printer, where complex features may be formed such as fluid channels and chambers or passageways for placing circuits, motors, or other components. In these embodiments, some of the surface members may be formed using UAM, and the remaining surfaces may be formed using PBF additive manufacturing.

Once the surface members are printed, they can be assembled together to form the box-like part. In some embodiments, the surface members can be connected using ultrasonic welding. In various embodiments, one or more of the surface members are connected via an adhesive or a mechanical fastener. As noted, the surface members may include protrusions, and various protrusions may be aligned to form a connection using one of the above techniques, for example. In various embodiments, one or more of the surface members include grooves into which the protrusions can be inserted to align and connect the surface members. The grooves and protrusions may be created using UAM, machined, or formed using another 3-D printing method such as PBF.

### UAM Systems

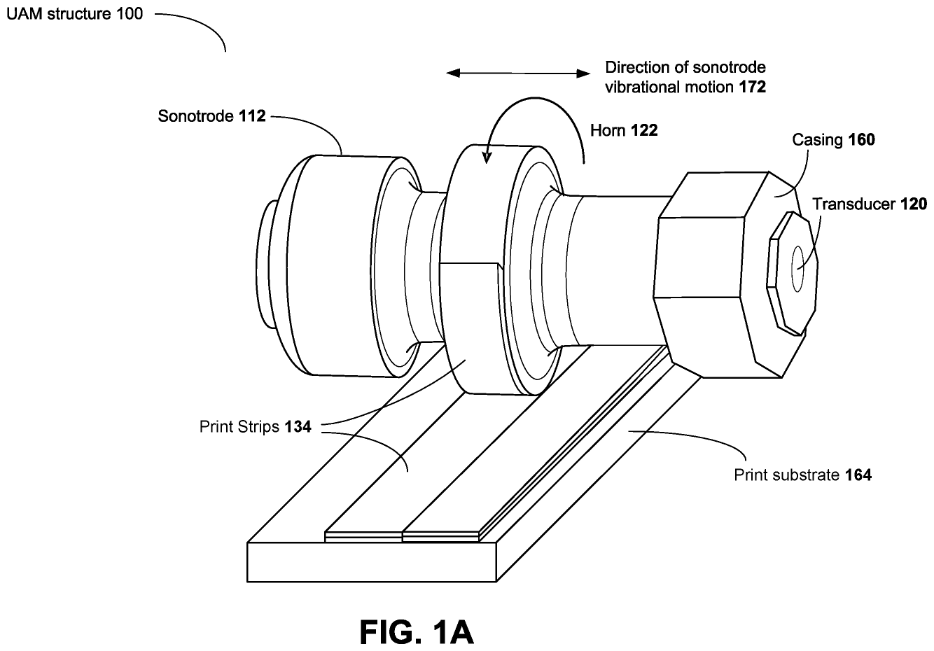

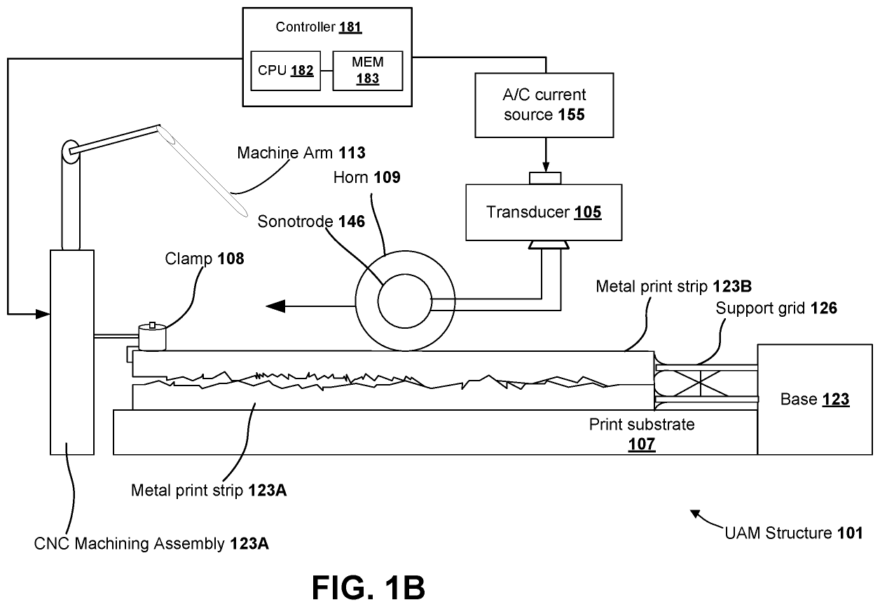

In UAM systems, metal structures can be created by ultrasonically welding together a plurality of layers of metal print strips. FIG. 1A is a perspective view of a conventional UAM structure 100. Structure 100 includes sonotrode 112. Sonotrode 112 includes a horn 122 and one or more transducers 120. In FIG. 1A, the physical elements of transducer 120 are included within the casing 160. Sonotrode 112 acts over a print substrate 164, or build plate, on metal print strips 134. The sonotrode 112 creates ultrasonic vibrations and applies these vibrations to the print strips 134 via horn 122. The vibrations are created by transducer 120, which may convert input power from a power supply into vibrations in an ultrasonic frequency range (e.g., 15-65 kilohertz (KHz)). For example, a piezoelectric material may receive an input current, which causes the material to vibrate at a resonant frequency. The transducer 120 may be coupled to the sonotrode 112 such that transducer 120 also causes the sonotrode 112 to vibrate.

When the print strips 134 are deposited on the print substrate 164 or on another strip, the horn 122 on the sonotrode 112 engages the metal strip and vibrates. The horn may have a surface texture that allows horn 122 to move the surfaces of two strips together to cause enough friction to remove the surface oxide layer from the metal strip through the force of the vibrational motion. The direction of the vibrational motion is shown by arrow 172. After stripping off the oxide layers from the print strips, the horn 122 can weld the two strips together by applying pressure.

As shown in FIG. 1A, the horn 122 can grip one of print strips 134 and roll it onto an existing strip. After the two strips are welded together, the sonotrode 112 can be repositioned to enable the UAM to retrieve another strip. The 3-D printing aspect of UAM is a regular series of individual ultrasonic welding operations, and a “build piece” can be created as more and more print strips are welded together as part of an overall computer-aided mechanical process.

FIG. 1B is a side cross-sectional view of a UAM structure with an integrated CNC machine. FIGS. 1A and 1B are not drawn to scale, and certain features may be enlarged relative to others for clarity. Here, horn 109 of sonotrode 146 is shown vibrating print strips 123B against a lower print strip 123A. While the surfaces of the print strips 123A and 123B may visually appear even from a distance, in fact they include rough edges which are exaggerated in FIG. 1B for illustration purposes.

A controller 181 includes a central processing unit 182 and a memory 183 for storing data and code. The code may include print instructions. The controller may cause an AC current source 155 to generate a current with a particular frequency to be applied to the transducer 105. In actual UAM systems, two or more transducers may be used. Transducer 105, which is coupled to the sonotrode and hence to horn 109, causes the rough surfaces of print strips 123A and 123B on print substrate 107 to vibrate against each other. The force of the horn 109 and the energy contained in the frequency of the vibrations dispel the oxide layer and cause ultrasonic welding of the strips at an atomic level.

In this illustrative UAM structure 101, a base 123 is coupled to the print substrate 107 or substrate to ensure a flat, stable surface. The base is coupled to a support grid, which in this embodiment is a small load-bearing framework used to stabilize the metal print strips currently being manipulated. FIG. 1B optionally includes a clamp 108 at the other end of the strips to provide further stabilization during the ultrasonic welding. A CNC machining assembly 123A, connected to machine arm 113, is integrated with the UAM structure 101 for performing machining. The machining assembly 123A enables greater design freedom by allowing the manufacturer to machine features into the build piece during the print, or after the print during post-processing.

### Box-Like Part

In an aspect of the disclosure, UAM is utilized to manufacture box-like parts. Box-like parts include a plurality of substantially flat, or at least partially flat, surface members. In UAM, the constituent pre-made metal print strips are generally provided with a larger horizontal (X-Y) surface area relative to their thickness in the vertical (Z) direction. Thus the UAM structure 100 is capable of efficiently rendering structures in the X-Y plane, i.e., a plane parallel to that of print substrate 164. That is to say, 3-D printing in the X-Y direction can be generally performed quickly and efficiently compared with other procedures because once the metal strips are deposited, they just need to be welded to adjacent strips. For this reason, UAM is a good candidate for 3-D printing structures that are generally flat, or that include large portions of flat material. For ease of explanation, the examples herein include rectangular structures. However, the box-like part is not limited to a rectangular geometry and instead may be any shape and may include any number of surfaces. In addition, the box-like part may include additional structures that can embody virtually any geometry.

In lieu of machining a block of material or 3-D printing an integral box-like part, UAM is utilized in this disclosure to separately additively manufacture (AM) the individual surface members that define or bound the box-like part. This enables manufacturers to capitalize on the benefits of the high-throughput rendering in the X-Y plane afforded by UAM. Once the surface members are 3-D printed using UAM, they may be assembled together to form the box-like part using any one or more of the techniques described herein. The adoption of a section-based approach of producing the surface members can improve overall efficiency in the AM process by increasing 3-D printer throughput. Printing structures in a flat orientation also reduces or eliminates the need for support structures traditionally used to support overhanging features during the 3-D printing process.

Because UAM is the cold-welding of metal sheets over each other, the resulting surface members lack the artifacts that are commonly observed in heat-intensive welding processes. Material and chemical properties of the resulting printed member will also be similar or identical to the properties of the raw material included in the print strips. This gives UAM a degree of predictability that may be lacking in conventional heat intensive processes, where the variable heat may alter the properties of the structure.

In some embodiments, UAM can be used to produce some of the surface members.

Remaining surface members that include complex internal passages can be produced using powder bed fusion (PBF) processes or other 3-D printing methods. PBF 3-D printer systems can produce build pieces with geometrically complex shapes, including some shapes that are difficult or impossible to create using conventional manufacturing processes such as machining or extruding. PBF systems create build pieces layer-by-layer. Each layer or slice is formed by depositing a layer of powder and exposing portions of the powder to an energy beam. The energy beam is applied to melt areas of the powder layer that coincide with the cross-section of the build piece in the layer. The melted powder cools and fuses to form a corresponding slice of the build piece. The process can be repeated to form the next slice of the build piece, and so on. Each layer is deposited on top of the previous layer. The resulting structure is a build piece assembled slice-by-slice from the ground up.

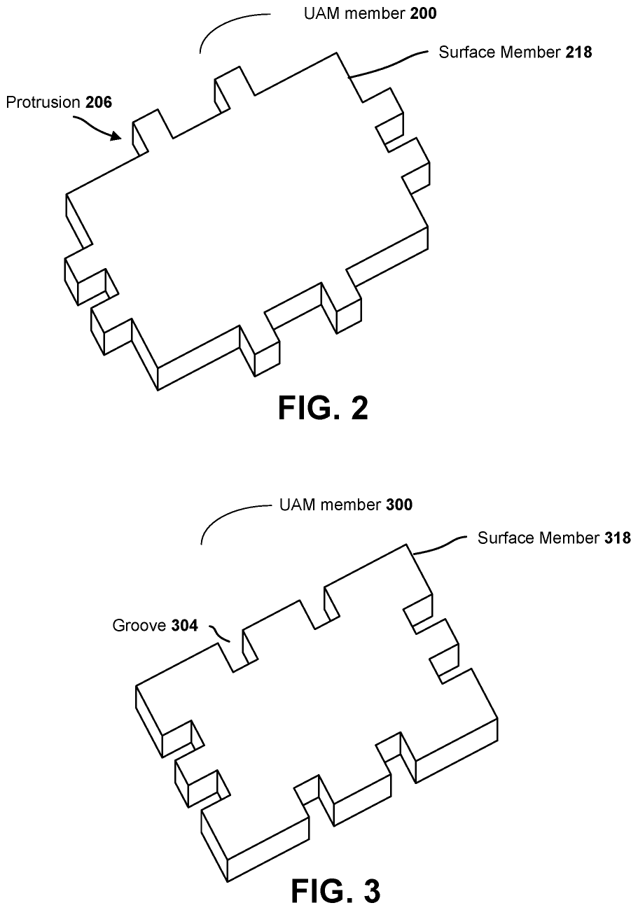

FIG. 2 is a perspective view of a UAM member 200 with protrusions. It is assumed that the member 200 was formed using UAM. While a simple flat surface member 218 is shown, the size and shape of the surface member 218 can vary. For example, the portion of the surface member 218 forming the interior of the box may be machined to form grooves, trenches, and other features. Surface member 218 includes a plurality of simple protrusions 206, or tabs, for facilitating connection of the surface member 218 to the remainder of the box-like part. The size and shape of the protrusions 206 may vary. In some embodiments, the protrusions are spaced closer to the edge, are much smaller than the body of surface member 218, or are protruding vertically relative to a plane of surface member 218. While two protrusions 206 per side are shown, further or less protrusions, or no protrusions, may be used as needed for different objectives or alternative geometries.

FIG. 3 is a perspective view of a UAM member 300 with grooves. The UAM member includes the surface member 318. The surface member 318 includes a plurality of grooves 304 along the perimeter of the surface member. The grooves 304 may be sized and shaped in different ways. In some embodiments, no grooves are used and either the edges of the surface members are connected together directly at their adjacent edges (e.g., through ultrasonic welding) or correctly-positioned protrusions are aligned directly to an edge of a complementary surface member. In some embodiments, the groove may extend as a recess or a stair step along part or all of the edge.

A significant advantage in UAM mentioned above is that the UAM process is driven by material deposition in the horizontal plane. Thus, unlike the conventional time-consuming approaches where box-like parts are machined from a singular large object or 3-D printed as an integrated structure, the surface members can be quickly 3-D printed using UAM. Once the UAM horn reaches the height of the surface member 318 and has deposited and welded the corresponding metal strips', the print may be complete and another surface member can be 3-D printed.

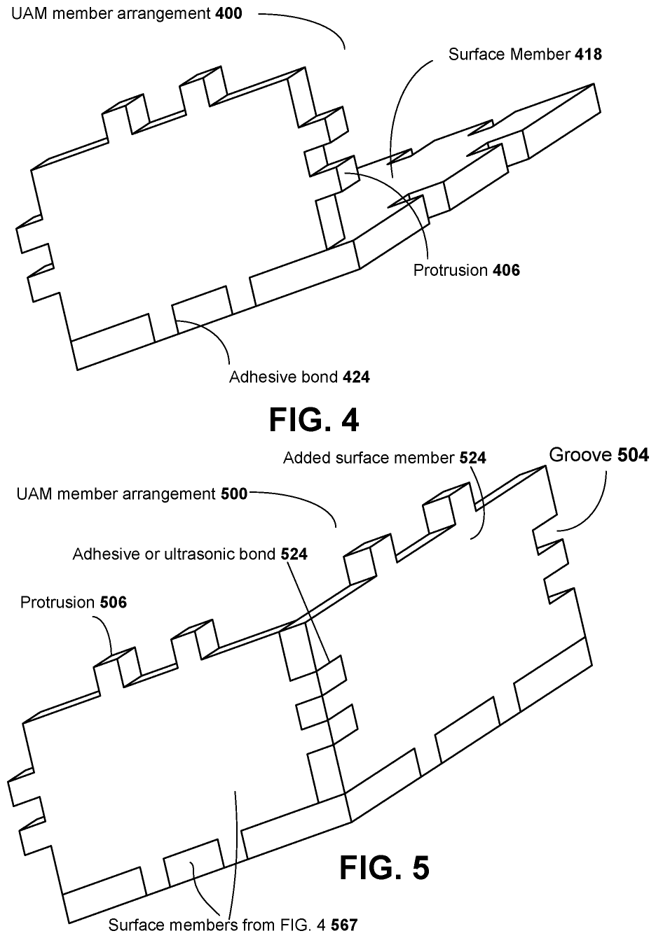

FIG. 4 is a perspective view of a UAM arrangement 400 with two connected surface members. In FIG. 4 it is assumed that all surface members 418 have been 3-D printed using the UAM process. Here, the protrusions of one surface member are inserted into the corresponding grooves and therefore aligned with the other surface member 418. The connection may be implemented by covering the inside of the groove with an adhesive prior to aligning the protrusion with the groove. In some embodiments, the edges of the surface member are bonded using ultrasonic welding. The ultrasonic welding can be performed at the protrusions and grooves, e.g., by using the UAM structure 100 to dispel the oxide surfaces at those locations and then to form an atomic-level bond after the protrusions and grooves are aligned and some threshold pressure is applied. In various embodiments where the protrusions are implemented in a different way or no protrusions are used, the necessary edge locations can be prepared and ultrasonic welding can weld edges of the surface members directly, or using just protrusions, or just stair-stepped recesses along the adjacent edges, etc.

In some embodiments involving part or all of the surface member connections, the surfaces can be connected using mechanical fasteners, adhesive bonds (e.g., as shown), heat-based welding, cold-spray, and the like.

FIG. 5 is a perspective view of a UAM member arrangement 500 of three connected surface members. An added surface member 524 is connected to the current surface members from FIG. 4 (567) by aligning the protrusions 506 and grooves 504 as shown. The new connection also shows a new adhesive bond 524 for embodiments that use adhesive.

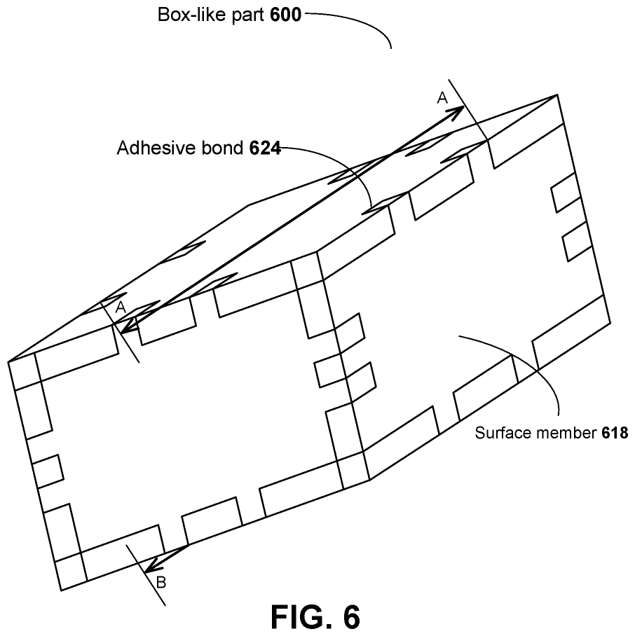

FIG. 6 is a perspective view of a box-like part 600 assembled based on the surface members in FIGS. 4-6. Here, each of the surface members 618 are assembled by aligning the protrusions and grooves, e.g., using ultrasonic welding, the adhesive bonds 624, mechanical fasteners, or a combination thereof. The box-like part 600 is closed. However, in various embodiments, one or more of the surface members 618 may be modified during the UAM process by using the CNC machining assembly, sometimes as integrated with the UAM structure 100. Trenches, holes, and other features may be machined into the surface member during the initial UAM process. Moreover, while the box-like part 600 is shown in the drawing as rectangular with six surface members, the principles of the disclosure extend to a different number of surface members to form another shape.

In many or most practical applications, the box-like part will include some asymmetries, may be coupled in part to non-flat structures or structures with curved edges, and may include a larger or smaller number of edges to produce a different geometric shape (e.g., a triangular structure or another polygonal structure). The present disclosure is intended to include each of these different possible embodiments.

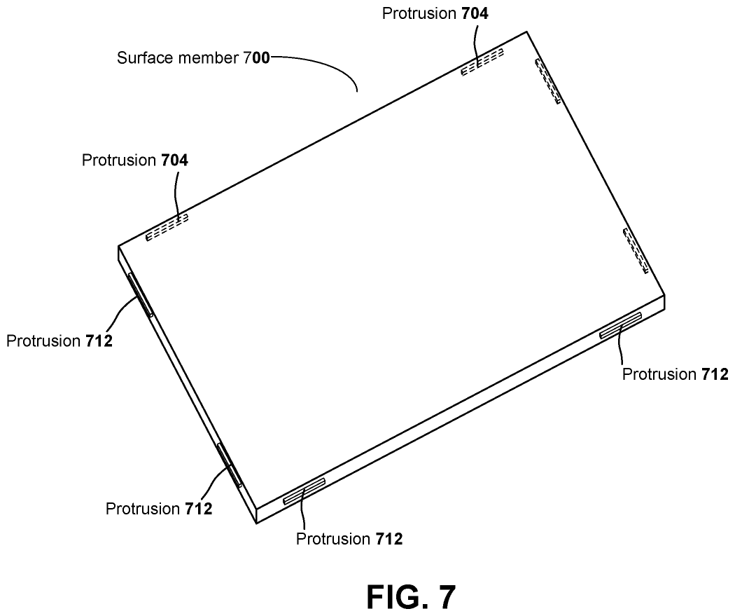

FIG. 7 is a perspective view of another surface member 700 with protrusions 704 and 712. The exterior surface of the surface member 700 is facing up in the view. Protrusions 712 extend around selected edges of the surface member 700. Other protrusions 704 extend vertically (here, downward) from the plane of the surface member 700. During the UAM process, the surface member 700 may be manufactured to include protrusions 704 and 712. The vertical height of the print is limited to the thickness of the surface member 700 plus the thickness of its protrusions 704. Thus, to maximize efficiency and help ensure a high throughput, printing the surface members in the vertical (Z) direction is minimized to this cumulative distance. The remaining portions of the UAM print are limited to only the thickness of the surface member 700.

In various embodiments, one or more protrusions may be used as locating features in an automated assembly of the surface members to form a box-like part. The locating features may be printed differently from the other protrusions, or they may be the same and positioned at a known orientation from one or more edges.

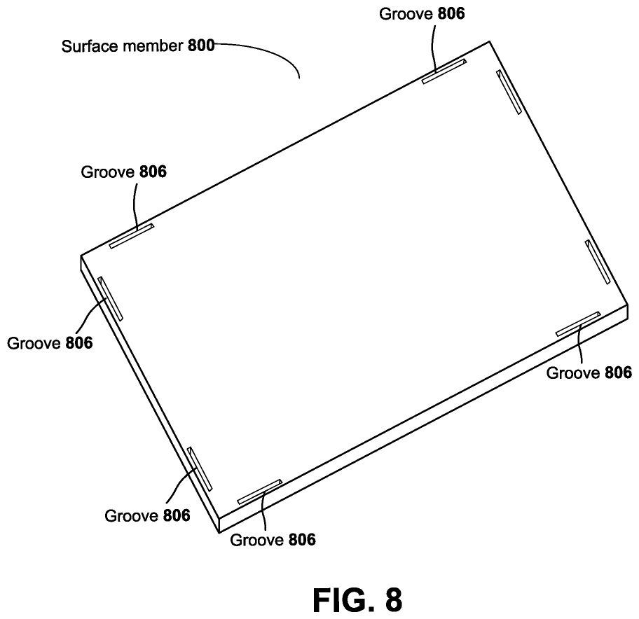

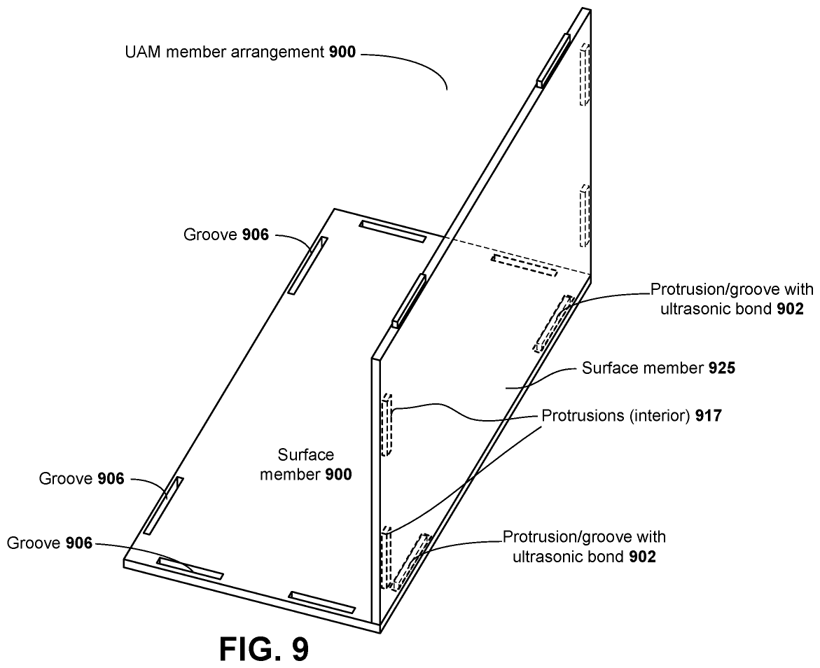

FIG. 8 is a perspective view of another surface member 800 with grooves 806. The grooves 806 may in some embodiments be machined by the CNC machine during the UAM operation. As in earlier embodiments, the grooves 806 may be positioned to receive complementary protrusions when assembling the box-like part. FIG. 9 is a perspective view of two connected surface members. Surface member 900 is shown with its interior side facing up. Grooves 906 are positioned proximate the edge of the surface member 900. Surface member 925 includes protrusions 917 that are positioned at various interior positions and edge positions of surface member 925. Near the intersection of the two surface members 900 and 925, the protrusions from surface member 925 are aligned with and seated in corresponding grooves in surface member 900. Just prior to bond formation, the groove and protrusion are treated at ultrasonic frequencies to dispel their surface oxides. Thereafter they are bonded together using pressure, forming protrusion/groove pairs 902 that are ultrasonically bonded.

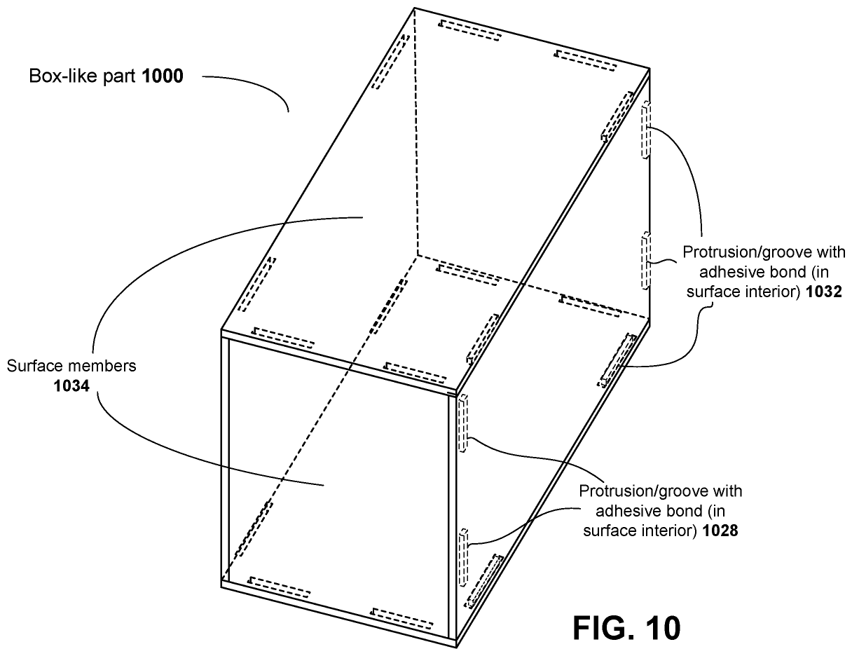

FIG. 10 is a perspective view of a box-like part 1000 assembled in part from the surface members in FIGS. 7-9. For simplicity, some details have been omitted from the litigation. The box-like part 1000 includes a plurality of adjoined surface members 1034, each of which were formed using UAM. Each of the protrusions on the various surface members have been aligned with corresponding grooves, and bonds have been formed such as adhesive bonds, ultrasonic bonds, or the like. As noted, in various embodiments, the protrusions have a different geometric shape. The protrusions may be aligned with each other, with the edge of an adjacent panel, or with a different groove. The number of protrusions and grooves may vary on each side. The box-like part is again shown for clarity in rectangular form, but it is not limited to this form and may include a larger or smaller number of surface members as well as surface members having different sizes or geometric shapes. As noted above, the surface member need not include four edges and in some embodiments, the surface member may be machined or otherwise 3-D printed to include round edges, angled edges, or edges with another style. The box-like part may in various embodiments be coupled to extruded parts or other box-like or 3-D printed parts.

The material characteristics and properties of the box-like part 1000 may vary depending on the material used to create the surface members. For example, the constituent print strips used in the UAM process may include a pure metal (e.g., aluminum, copper, iron, etc.) or it may include a metal alloy. In more sophisticated applications, the surface members may be created using different metal print strips with different properties. Further, the different surface members of a box-like part may each include different properties to obtain an overall set of properties that is a mix of the original metals or alloys, or a continuously varying set of properties that are distributed over the metal.

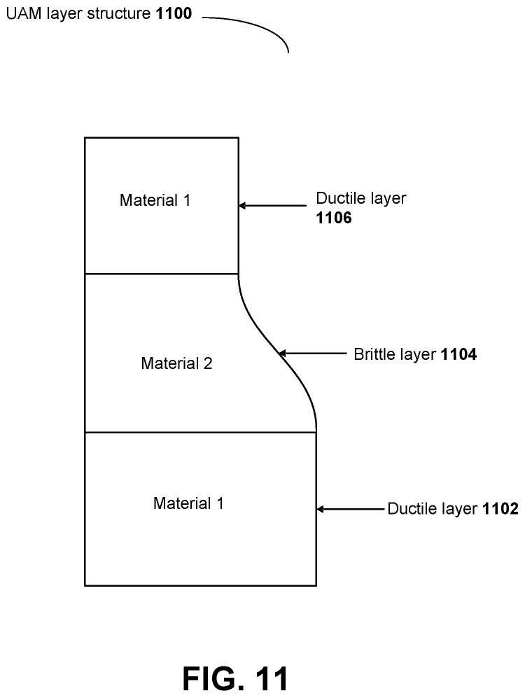

FIG. 11 is a cross-sectional view of an edge of a UAM layer structure 1100 with different materials 1 and 2. The vertical direction on the figure may correspond to a vertical direction relative to a print substrate (e.g., print substrate 164). The structure 1100 may correspond to a small section of a larger surface member. It may be desirable to vary the properties in the materials for a different application. For example, a base layer of the structure 1100 may be composed of a first material (material 1) that gives the layer ductile properties. Thus the layer is a ductile layer 1102. For the middle layer of the structure 1100, it may be desirable to include a second material that is brittle, in order to create a brittle layer 1104. The third layer may be a ductile layer 1106 and incorporate material 1 as well. The end result is a surface member which has a set of properties defined by the combination of these materials. Different numbers of layers and materials are possible.

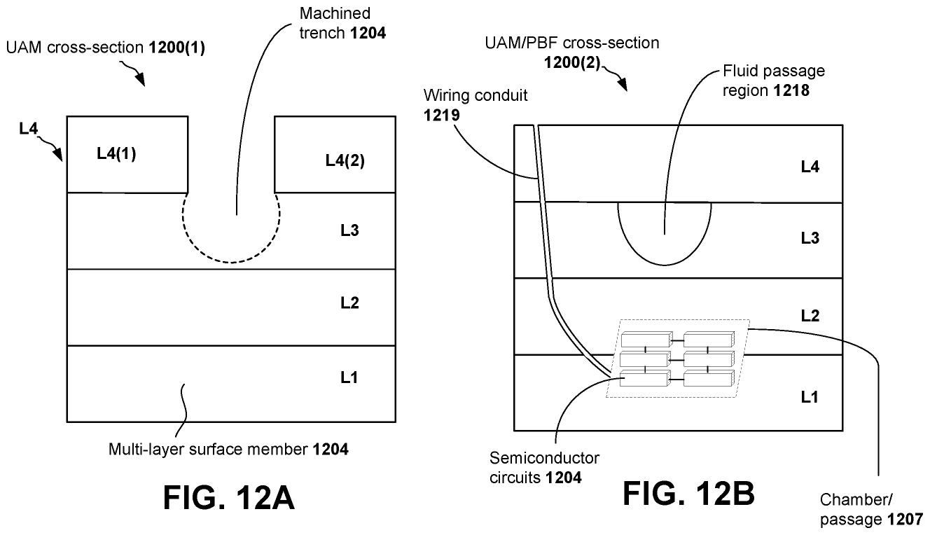

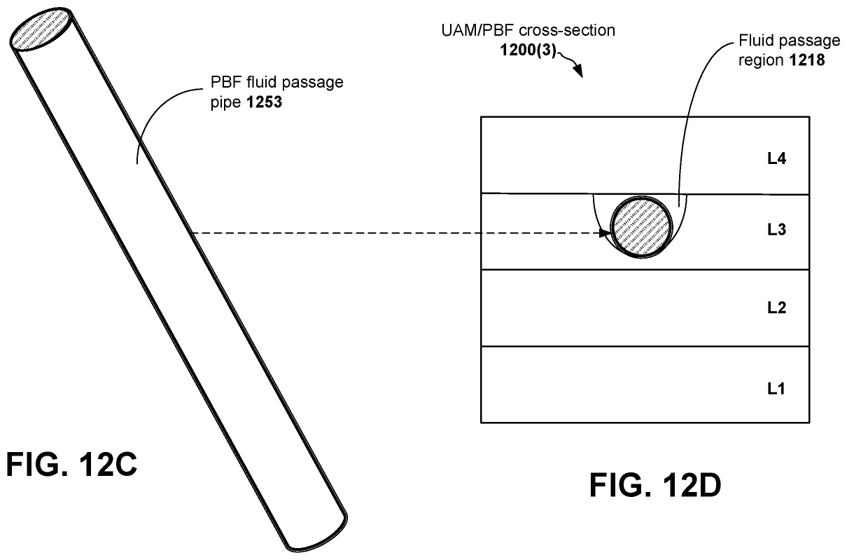

FIG. 12A is a cross sectional view of a portion 1200(1) of a multi-layer surface member 1204. Like in FIG. 11, FIG. 12A shows a cross-sectional portion of a surface member 1204 that may be a small portion of a larger surface member with multiple layers in the Z direction. For example, the different layers L1-L4 may include different materials which begin as metal print strips and which are subsequently positioned and bonded together during UAM. In some arrangements the layers include the same materials, and therefore the layers may represent different metal print strips of the same material that form a single metal bond. In various embodiments, the layers include different materials, such as aluminum in layers 1 and 4, and different aluminum alloys in layers 2 and 3 respectively.

In some arrangements, after UAM lays down print strips corresponding to L3, the UAM may temporarily suspend printing. The trench 1204 may be machined out from L3 at that point in the process. Next, when L4 is deposited over L3, the UAM printer can position the two L4 layers, such as L4(1) and L4(2), to not obstruct the opening 1204 made by the CNC machine. In these embodiments, for the remainder of the surface member, the UAM printer can position the L4 layers such that they do not overlap the trench 1204. These embodiments reduce overall material wastage because only L3 is machined, rather than L4.

In various embodiments in FIG. 12A, trench 1204 may instead be formed after layers L3 and L4 are fully deposited using UAM. For example, in these embodiments, the four layers L1-4 are deposited and bonded using UAM. Thereafter, the CNC assembly may machine a well or trench 1204 by milling both L3 and L4 to form the cavity.

Trench 1204 may be formed to extend laterally along a plane of the surface member. In some embodiments, a plurality of trenches are machined to run laterally across the surface member. The surface portion (L4) of the surface member may represent an interior surface of what will become a box-like structure. The trench 1204 is one of many possible embodiments formed by the machine assembly. The machine may mill a variety of shapes into the interior or exterior surface of the surface member depending on the application. Use of integrated machine capability in the context of building surface members for box-like parts provides great flexibility in manufacturing applications.

In some cases, the surface member may include more sophisticated features such as routing channels for fluid within one or more surface members. In other embodiments, it may be desirable to build sophisticated chambers within the metal layer in order to encase structures. For instance, the surface member may be thick enough to accommodate an integrated circuit and a wiring conduit, as described further below.

In some cases, the part to be built may include one or more parts that require features that are too sophisticated to be implemented using UAM. In another aspect of the disclosure, one or more of the surface members are instead 3-D printed using a PBF printer. As described above, a PBF printer includes a chamber with a build plate onto which layers of a metal power material are deposited. The PBF printer includes an energy beam source such as a laser or an electron beam. The energy beam source scans a layer of newly deposited powder under control of a controller. The controller has compiled a design model into a sequence of 3-D print instructions. The energy beam source scans, melts, and solidifies a cross-sectional layer of the metal material that corresponds to a section of a build piece in that layer. After scanning, the PBF printer deposits another layer of powder, and the energy beam source scans the next layer to produce the next cross-section, and so on until the build piece is completed.

FIG. 12B is a cross sectional view of a portion of a multi-layer surface member 3-D printed having various features. In some embodiments, the surface member including cross-section 1200(2) may be printed using UAM. In these initial embodiments, the features included in L1 and L2 and the wiring conduit 1219 are not included. The PBF printer constructs a surface member including the UAM cross-section 1200(2) with the first three layers L1-L3. UAM printing is then temporarily suspended. The machine may be used to form a cavity in L3. In the arrangement shown, a cavity that corresponds to fluid passage 1218 is formed along a plane of the surface member. After the cavity is machined in L3, UAM may resume, and L4 is deposited. The deposition of L4 completes formation of fluid passage 1218. The passageway 1218 may enable fluid to flow through the surface member. The passageway 1218 may be useful in the event the interior of the box-like part includes a motor or other mechanism that generates significant heat. In various other embodiments, a tubular-shaped PBF part may instead be inserted into layer L3, as discussed further below with reference to FIGS. 12C and 12D.

In various embodiments, the box-like part may be created using a combination of UAM-printed surface members and, for example, one or more surface members printed using PBF. It may be desirable to print one of the surface members using PBF where the surface member requires sophisticated geometrical features that cannot be implemented using UAM. As an example, the cross-section 1200(2) of FIG. 12(B) and the corresponding surface member may be printed using a PBF printer. The PBF printer may also print a chamber 1207 in the surface member designed to accommodate integrated circuits 1204, as well as a small wiring conduit 1219 to pass signals to and from the integrated circuits and an internal region of the box-like part. Support structures may be used, if necessary, during the PBF print. After the completed surface member including cross-section 1200(2) is removed from the printer, the integrated circuits or wiring may be installed within the chamber. If such post-processing installation is impractical or impossible due to the closed nature of the chamber, in some embodiments PBF printing can be interrupted before completing the upper surface of the passageway to insert the circuits 1204 or other components into the space 1207. 3-D printing can then resume.

In general, in this aspect of the disclosure, a portion of surface members that require an enhanced level of structural sophistication may be 3-D printed using a PBF printer, while the remainder of the surface members may be 3-D printed using UAM, and, where necessary, CNC machining. The box-like part may then be assembled from the combination of PBF-printed surface members and UAM surface members. These embodiments maximize efficiency and print speed (due to UAM) while adding the necessary structural capability to the part (using UAM, machining, or PBF).

A relatively simple chamber 1207 and wiring conduit 1219 is illustrated in FIG. 12B. The disclosure is not so limited, however, and PBF may be used to introduce virtually any kind of geometrically sophisticated structure within a surface member using PBF, while concurrently forming the other surface members using the speed and efficiency of UAM.

In various embodiments, a box-like part may be generated using UAM to produce the surface members. In these embodiments, PBF may be used to print structures of a given geometry that are configured to fit within an available region of a surface member (or to connect to a surface member). A simple example of these embodiments is shown in FIG. 12C. A PBF fluid passage pipe 1253 for fluid passage may be printed with custom features. For example, the fluid passage pipe may be curved or it may fan out to additional pipes. In some embodiments, a COTS pipe or other COTS component may be used, if available. The fluid passage pipe 1253 can then be inserted into a region formed in the surface member. FIG. 12D is a cross sectional view 1200(3) of the surface member having the fluid passage region 1218 formed with reference to FIG. 12B. After L3 is deposited using UAM printing, the UAM may be temporarily suspended. At this time, the PBF fluid passage pipe 1253 of FIG. 12C can be inserted into the fluid passage region 1218. UAM printing may then resume, with L4 being overlaid and thereby integrated with L3. While an example relevant to fluid flow is shown, other embodiments are possible. The surface member including cross section 1200(3) may be machined to include different regions into which various PBF printed structures for performing different functions can be positioned.

In another aspect of the disclosure, the UAM may be configured to create vehicle parts including crash structures. Crash structures and extrusions generally rely on flat surfaces, making the box-like part ideal for such structures. Crash structures in automobiles, for instance, may include the extrusion beams at the front and rear ends. They may also be built in the interior of the vehicle at various points to reduce the force that is experienced by the driver in an impact event. Crash structures may include crumple zones that are designed to deform in an anticipated way to enable the brunt of the impact to crumple the crash structure and thus mitigate the potential for driver or passenger injury. Regions which are not connected by ultrasonic welds can function as crush initiators in an impact event. This may improve the energy absorption characteristics of the crash structure by ensuring a controlled collapse of the structure, which limits peak loads borne by the vehicle and its occupants. Multiple cross-sections, which may be designed through topology and gauge optimization processes to satisfy vehicle safety requirements or performance, can be produced using these embodiments.

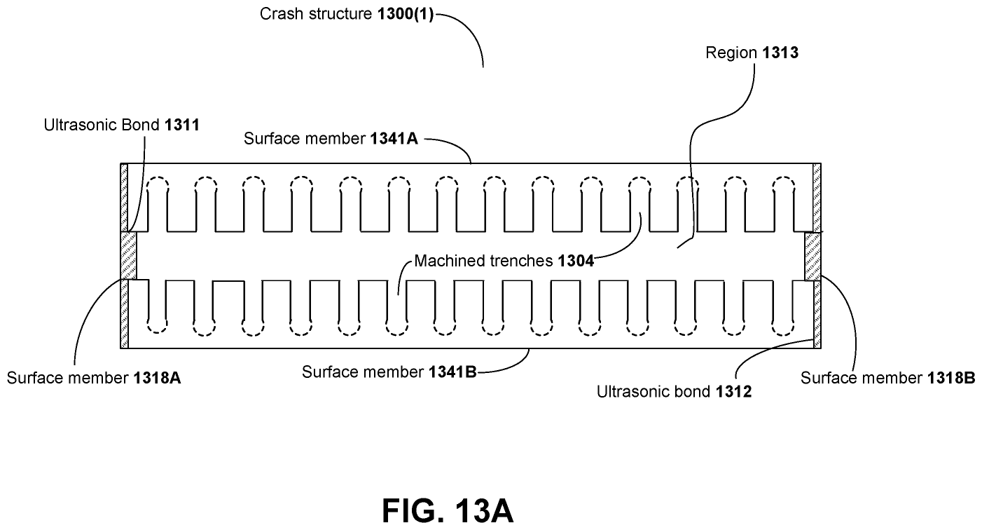

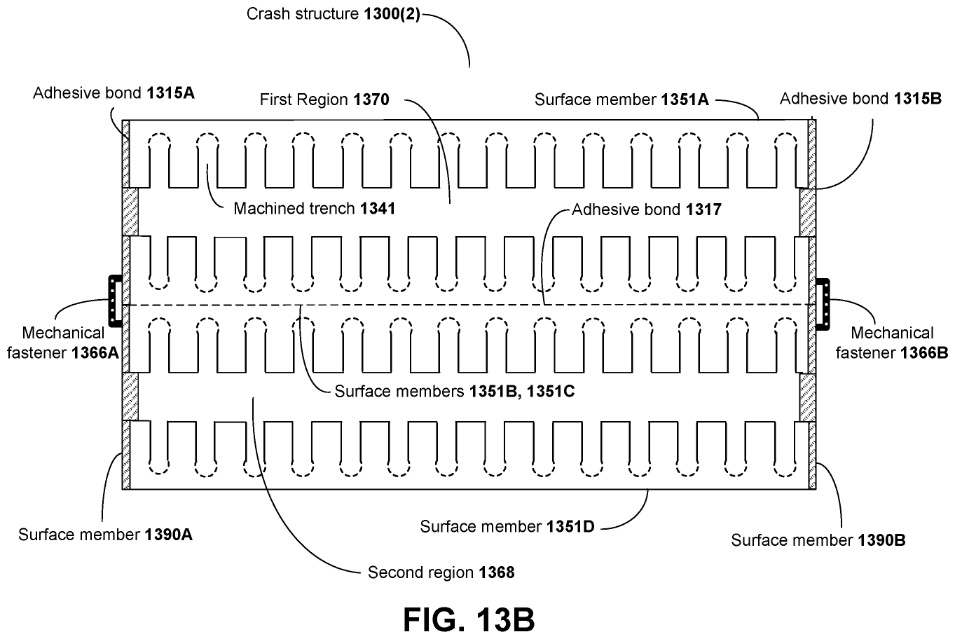

FIG. 13A is a cross-sectional side view of an exemplary crash structure 1300(1) using surface members with distributed trenches. Like the other figures, FIG. 13A is not drawn to scale. For clarity, the view of FIG. 13A may be taken along the plane defined by the lines AA and BB in FIG. 6. Crash structure 1300(1) may otherwise differ from the structure in FIG. 6. Two surface members 1318A and 1318B are shown extending out of the drawing from the viewers perspective. They are connected to surface members 1341A and 1341B via respective ultrasonic bonds 1311 and 1312. Together, the four connected surface members bound a region 1313.

During the individual UAM operations on surface members 1341A and 1341B, the

CNC machine assembly may be used to machine a distributed set of trenches 1304 into respective interior surfaces of the surface members 1341A and 1341B. These trenches 1304 may be used to optimize deformation of the crash structure 1300(1). The trenches may be made substantially in the manner described with respect to FIG. 12A.

FIG. 13B is a cross-sectional side view of another exemplary crash structure 1300(2) using surface members 1351A-D with distributed trenches 1300(2). While not drawn to scale, the crash structure 1300(2) of FIG. 13B is designed to show the flexibility of the techniques described. For example, a more sophisticated crash structure can be created by separately manufacturing surface members 1351B and 1351C, including machining portions of these structures to produce the distributed trenches in the interior portion. To create additional resistance to an impact force, the smooth sides of surface members 1351B and 1351C can be connected together, using an adhesive to create the adhesive bond 1317 shown, or by using an ultrasonic bond and avoiding the necessity of additional bonding materials. Thus, surface members 1351A and 1351B, together with a first portion of surface members 1390A and 1390B, define a first region 1370. Surface members 1351C and 1351D, together with a second portion of surface members 1390A and 1390B, define a second region 1368.

Further, as an additional or different measure, mechanical fasteners 1366A may be coupled to surface members 1390A and 1390B and may extend into the interior of the structure 1300(2) to connect surface members 1351B and 1351C together (not shown) for additional reinforcement, or as optional separate connections. Mechanical fastener 1366B may perform substantially the same functions on the other side of the crash structure 1300(2).

Trenches 1341 are also included in the embodiment of FIG. 13B on the interior surface of surface members 1351A-D. The architecture of FIG. 13B may be appropriate as crash structures for larger vehicles where a greater amount of force is required to cause damage to the vehicle or injury to the vehicle occupants. FIG. 13B demonstrates that combinations of box-like parts can be integrated together into a combination of multiple structures after the surface members are manufactured.

Another advantage of these principles is the non-design specific nature of additive manufacturing. In conventional techniques where conventional extrusion is used to produce structure, any design changes require a substantial effort to replace the underlying equipment. By contrast, design changes using the present disclosure may simply involve modifying the software-based design model representing the surface member to be changed, and 3-D printing the modified part based on the revised design model.

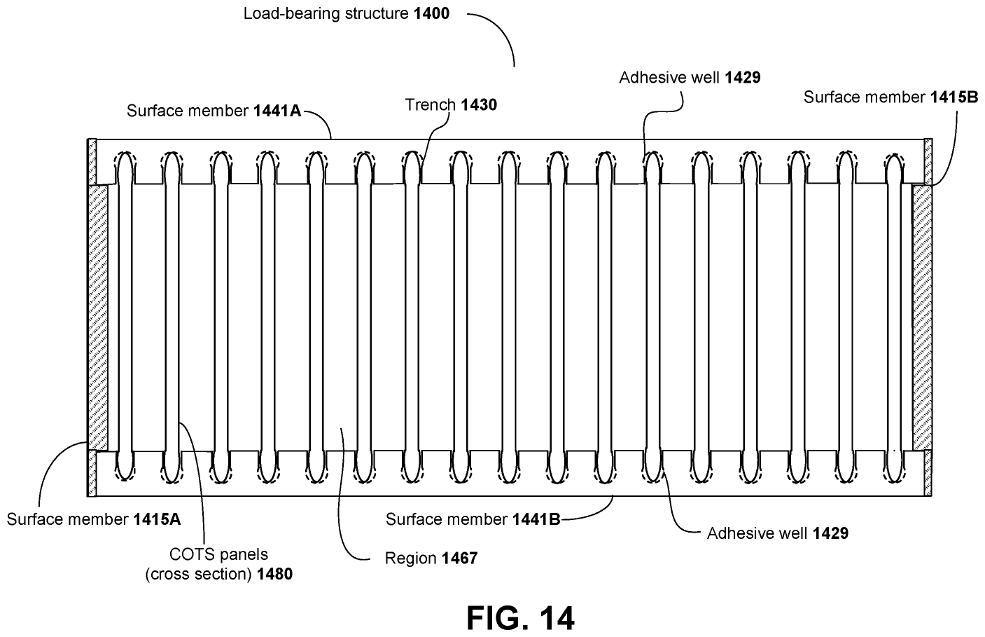

FIG. 14 is a cross sectional side view of an exemplary load-bearing structure 1400 using COTS panels 1480. The structure illustrated, and variations thereof, may be used as parts in transport structures and stationary mechanized assemblies. Structure 1400 may be modified as necessary for use as a crash structure, a reinforcing structure, and a load structure for supporting one or more loads. Like FIG. 13A, FIG. 14 may be visualized as a cross section of a generally rectangular structure along the planes defined by AA and BB of FIG. 6. Also, like FIG. 13A, the structure in FIG. 14 may differ in other material respects from that of FIG. 6.

The surface members 1415A, 1415B, 1441A and 1441B are 3-D printed using UAM, as in previous embodiments. An integrated CNC machine may also create trenches 1430, which may be distributed across part or all of the interior surfaces of surface members 1441A and 1441B. Surface members 1415A, 1415B, 1441A and 1441B are thereafter assembled together to form region 1467. In some embodiments, COTS panels are inserted into structure 1400 prior to sealing the structure shut. The COTS panels may be inserted in corresponding aligned and opposite facing trenches 1439. A bottom portion of the trenches 1430 may form an adhesive well 1429, for applying a bonding material prior to insertion of the COTS panels 1480. In some embodiments, bars tubes, or other COTS structures may be substituted for COTS panels 1480.

In FIG. 14, the build of load-bearing structure 1400 may be optimized by forming the custom parts using UAM and the commercially available parts using COTS parts to produce the necessary structure at the highest speed and the lowest cost.

The order of assembly in some embodiments may include binding the surface members at the bottom, then the sides, and then the top. This order of construction helps increase the fidelity of the connections. It also enables the manufacturer to insert and connect structure, where necessary, within the box-like part.

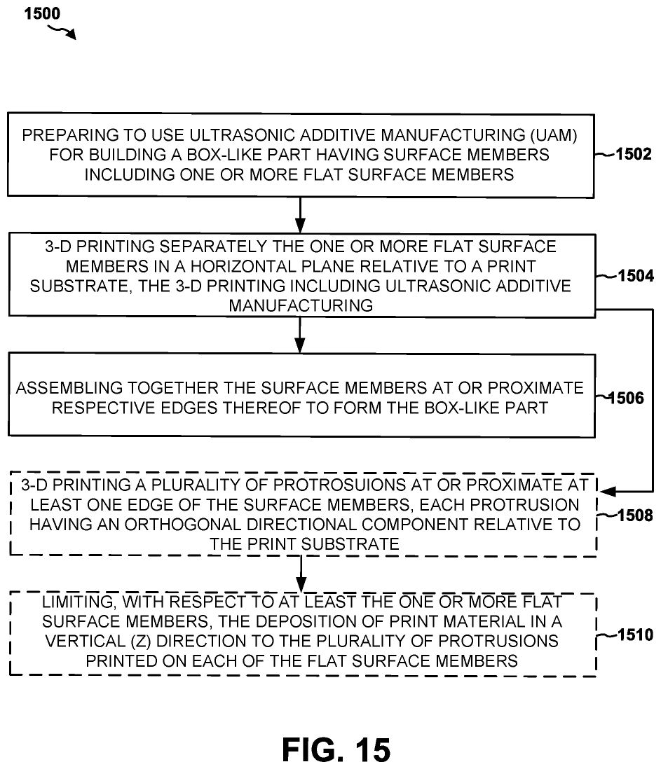

FIG. 15 is an exemplary flow diagram 1500 of a method for building box-like part using UAM. The steps in FIG. 15 may be performed by a UAM 3-D printer such as the printer shown in FIGS. 1A and 1B, programmed or configured (e.g., in memory 183) to 3-D print the structure (e.g. using controller 181 including CPU 182 and memory 183) using instructions compiled based on software design models of the surface members. The dashed rectangles indicate optional features or embodiments.

At 1502, a UAM 3-D printer is appropriately programmed in preparation to use the UAM to build a box-like part having surface members including one or more flat surface members. At 1504, the UAM 3-D printer separately prints each of the one or more flat surface members in a horizontal plane relative to a print substrate, the 3-D printing including ultrasonic additive manufacturing. At 1506, the surface members may be assembled together at or proximate respective edges thereof to form the box-like part.

In some embodiments, at 1508, the UAM 3-D printer 3-D prints a plurality of protrusions at or proximate at least one edge of the surface members, each protrusion having an orthogonal directional component relative to the print substrate. Thus, in this embodiment, the protrusions may be configured to extend out in at least a vertical direction from the surface of the surface member. In some embodiments, at 1510, the UAM 3-D printer is configured to limit, with respect to at least the one or more flat surface members the deposition of print material (e.g., metal print strips) in a vertical (Z) direction to the plurality of protrusions printed on each of the flat surface members. As a result, upon 3-D printing the protrusions, the UAM 3-D printer no longer prints additional vertical structure. This limitation helps ensures that the efficiency of the manufacturing process is maintained by maximizing use of UAM to the horizontal (X-Y) direction.

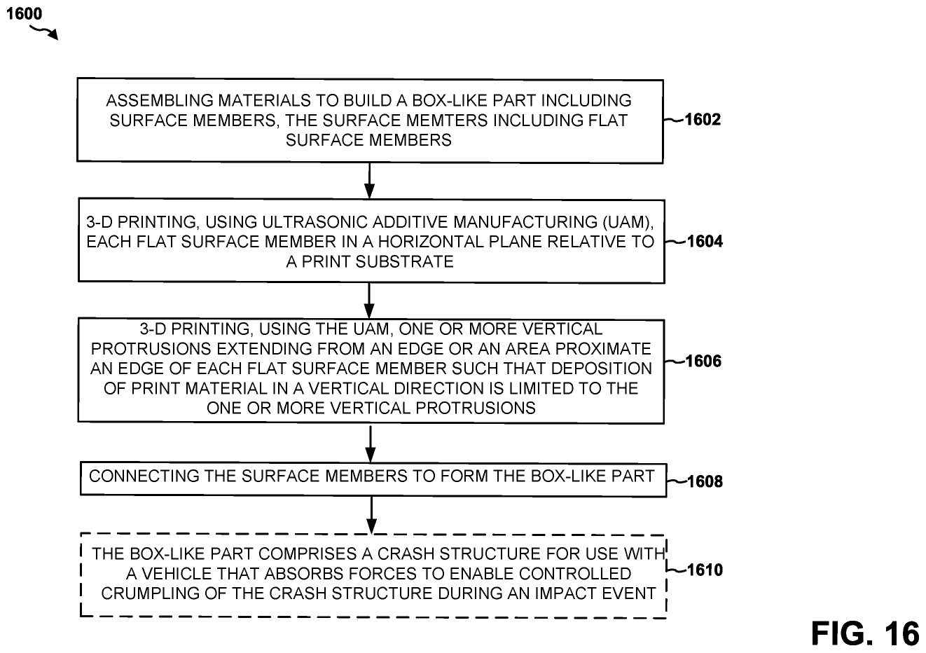

FIG. 16 is another exemplary flow diagram 1600 of a method for building a box-like part using UAM. These steps may be performed by the UAM 3-D printer of FIGS. 1A and 1B, for example. At 1602, the materials are assembled to build a box-like part including surface members, the surface members including flat surface members. At 1604, the UAM 3-D printer 3-D prints, using UAM, each flat surface member in a horizontal plane relative to a print substrate. At 1606, the 3-D printer 3-D prints, using UAM, one or more vertical protrusions extending from an edge or an area proximate an edge of each flat surface member such that deposition of print material in a vertical direction is limited to the one or more vertical protrusions. At 1608, the surface members are connected to form the box-like part. At 1610, the box-like part may include a crash structure for use with a vehicle that absorbs forces to enable controlled crumpling of the crash structure during an impact event.

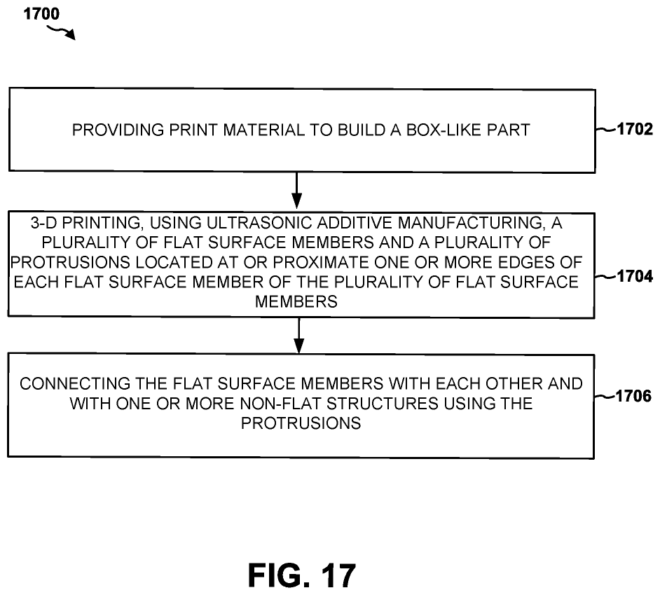

FIG. 17 is an exemplary flow diagram a method for building box-like part using UAM. As in the FIGS. 15 and 16, the steps may be performed by an UAM 3-D printer, such as the one described with respect to FIGS. 1A and 1B. Print material is provided to build a box-like part at 1702. At 1704, the UAM 3-D printer 3-D prints, using ultrasonic additive manufacturing, a plurality of flat surface members and a plurality of protrusions located at or proximate one or more edges of each flat surface member of the plurality of flat surface members. At 1706, the flat surface members are connected with each other and with one or more non-flat structures using the protrusions.

The principles of this disclosure solve the problems commonly associated with the tooling-heavy extrusion process (which can often be expensive and inflexible) while helping manufacturers benefit from the advantages of flexible, non-design specific AM, and while meeting throughput requirements that are challenging to achieve with conventional methods. Additionally, the principles herein enable manufacturers to pursue a hybrid AM approach (e.g., UAM and PBF) such that complex features are managed using PBF and the substantially flat geometries are 3-D printed using UAM to meet overall system costs and productivity goals.

The principles of this disclosure also enable vehicle manufacturers and other manufacturers of complex mechanical systems to produce box-like parts that are ideal representations of optimized designs. The advantages are achieved due to the non-design specific nature of AM, the achievable high throughput of UAM in producing box-like parts by UAM, and the criteria of limiting Z-axis complexity to specific regions. Furthermore, these principles can drive shorter product cycles for automotive and other vehicle manufacturers as they reduce the reliance on tooling locked to a specific design or vehicle.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method for building a box-like part having surface members, the surface members comprising one or more flat surface members, the method comprising:
3-D printing separately the one or more flat surface members in a horizontal plane relative to a print substrate, the 3-D printing comprising ultrasonic additive manufacturing (UAM); and
assembling together the surface members at or proximate respective edges thereof to form the box-like part.

2. The method of claim 1, wherein the surface members include at least one surface member having an internal volume or a non-flat surface geometry.

3. The method of claim 2, further comprising 3-D printing, using a powder bed fusion (PBF) printer, at least a portion of the at least one surface member having the internal volume or the non-flat surface geometry.

4. The method of claim 2, wherein the internal volume comprises a channel for enabling fluid flow.

5. The method of claim 1, further comprising:
3-D printing a plurality of protrusions at or proximate at least one edge of one or more of the surface members, each protrusion having an orthogonal directional component relative to the print substrate;
wherein assembling together the surface members comprises establishing connections between adjacent surface members using the plurality of protrusions.

6. The method of claim 5, further comprising limiting, with respect to at least the one or more flat surface members, the deposition of metal print strips in a vertical (Z) direction to a height of the plurality of protrusions printed on each of the one or more flat surface members.

7. The method of claim 5, further comprising:
3-D printing a plurality of grooves at or proximate at least one edge of one or more of the surface members,
wherein establishing connections between adjacent surface members to form the box-like part comprises aligning protrusions with complementary grooves, of the plurality of protrusions and grooves, for the adjacent surface members.

8. The method of claim 7, further comprising using ultrasonic welding at the aligned complementary protrusions to weld together the surface members to form the box-like part.

9. The method of claim 1, wherein the assembling the surface members to form the box-like part comprises using one or more of welding, mechanical fastening, or adhesive bonding to connect adjacent surface members together.

10. The method of claim 1, wherein 3-D printing the one or more flat surface members comprises forming locating features at or near edges of the one or more flat surface members.

11. The method of claim 1, wherein the box-like part comprises a crash structure that absorbs forces to enable controlled deformation of the crash structure included with a vehicle during an impact event.

12. The method of claim 11, further comprising using a computer numerical control (CNC) machine that partially vacates an interior surface of at least one of the surface members to create a plurality of trenches distributed across part or all of the interior surface.

13. The method of claim 12, wherein the trenches are configured to facilitate the controlled deformation of the crash structure during the impact event of a vehicle within which the crash structure is installed.

14. A method for building a box-like part comprising surface members, the surface members comprising flat surface members, the method comprising:
3-D printing, using ultrasonic additive manufacturing (UAM), each of the flat surface members in a horizontal plane relative to a print substrate,
3-D printing, using UAM, one or more vertical protrusions extending from an edge or an area proximate an edge of each flat surface member such that deposited print strips in a vertical direction are limited to the one or more vertical protrusions; and
connecting the surface members using the protrusions to form the box-like part.

15. The method of claim 14, wherein connecting the surface members to form the box-like part comprises aligning the protrusions with complementary grooves located on adjacent surface members.

16. The method of claim 14, further comprising using ultrasonic welding to connect the surface members.

17. The method of claim 14, further comprising using one or more of mechanical fastening, welding, adhesive, and cold spray to connect the surface members.

18. The method of claim 14, wherein the surface members comprise at least one surface member having an internal structure or a non-flat geometry.

19. The method of claim 18, wherein the box-like part comprises a crash structure for use with a vehicle that absorbs forces to enable controlled crumpling of the crash structure during an impact event.

20. A method for building a box-like part, comprising:
3-D printing, using ultrasonic additive manufacturing, a plurality of flat surface members and a plurality of protrusions located at or proximate one or more edges of each flat surface member of the plurality of flat surface members; and
connecting the flat surface members with each other and with one or more non-flat structures using the protrusions.
